(19) United States
(12) Patent Application Publication
(10) Pub. No.: US 2004/0023552 A1
(43) Pub. Date: Feb. 5, 2004

(54) Serial ATA cable

(76) Inventor: Wilson Chen, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/207,214

(22) Filed: Jul. 30, 2002

(51) Int. Cl. H01R 11/00

(52) U.S. Cl. 439/502

(57) ABSTRACT

A serial ATA cable is constructed to include a cable formed of four twisted pairs arranged in parallel, and two serial connectors at two distal ends of said cable, each twisted pair of the cable including a signal wire and a grounding wire twisted with the signal wire.

### BACKGROUND OF THE INVENTION

1. Field of the Invention

The present invention relates to a serial ATA cable and, more particularly, to such a serial ATA cable, which eliminates interference between signal wires.

2. Description of the Related Art

FIGS. 1 and 2 show a serial ATA cable constructed subject to the definitions made by American Serial ATA. As illustrated, the serial ATA cable is comprised of a cable 10 and two connectors 12 at the ends of the cable 10. The cable 10 comprises a pair of electrically insulative plastic shells 14 of oval cross-section about 0.35 m˜1 m long. Each plastic shell 14 holds a pair of signal wires 16 and a pair of grounding wires 18. The grounding wires 18 are arranged in parallel at two sides of the signal wires 16. The signal wires 16 are arranged in parallel and surrounded by a tube of aluminum foil 20 in the plastic shell 14 between the grounding wires 18. This design of serial ATA cable has drawbacks as outlined hereinafter.

1. The signal wires 16 may interfere with each other, resulting in unstable transmission of signal. This signal interference problem becomes apparent under the data transmission speed of 150 MB/sec. Further, the intensity of the interference between the signal wires 16 increases with the length of the signal wires 16.

2. The hard plastic shell 14 of the serial ATA cable makes the installation and positioning of the serial ATA cable in the host computer difficult.

### SUMMARY OF THE INVENTION

The present invention has been accomplished under the circumstances in view. It is therefore the main object of the present invention to provide a serial ATA cable, which eliminates interference between signal wires. It is another object of the present invention to provide a serial ATA cable, which achieves stable transmission of data. It is still another object of the present invention to provide a serial ATA cable, which is easy and convenient to install. According to the present invention, the cable of the serial ATA cable is formed of four twisted pairs arranged in parallel. Each twisted pair of the cable is comprised of a signal wire and a grounding wire twisted with the signal wire. Because the signal wires are respectively grounded, the length of the signal wires does not affect the stability of the transmission of data of the serial ATA cable. Further, because no hard plastic shell is used, the serial ATA cable can easily be positioned in the host computer.

### BRIEF DESCRIPTION OF THE DRAWINGS

FIG. 1 illustrates a serial ATA cable constructed according to the prior art.

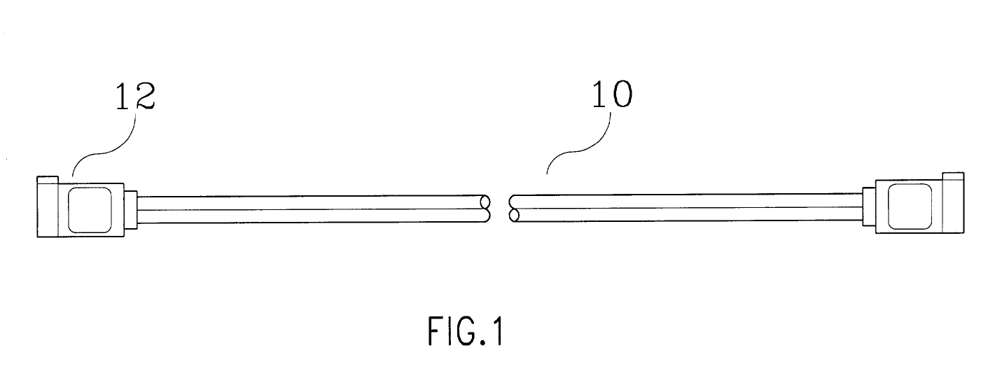

FIG. 2 is a sectional view in an enlarged scale of the serial ATA cable shown in FIG. 1.

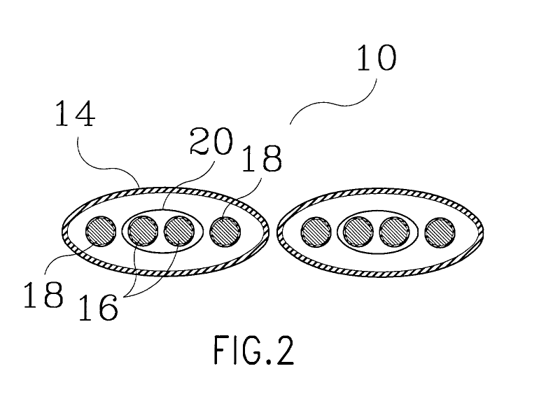

FIG. 3 illustrates a serial ATA cable constructed according to the present invention.

FIG. 4 is a schematic drawing showing the arrangement of the signal and grounding wires of the serial ATA cable according to the present invention.

### DETAILED DESCRIPTION OF THE PREFERRED EMBODIMENT

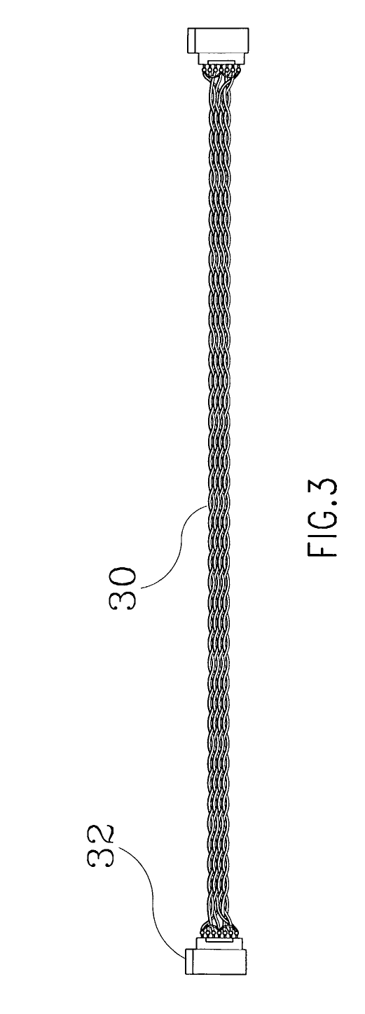

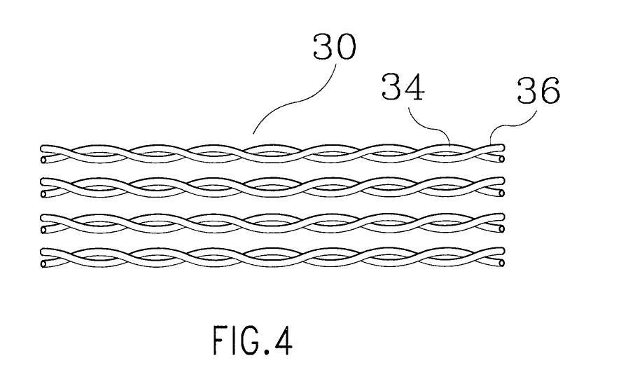

Referring to FIGS. 3 and 4, a serial ATA cable in accordance with the present invention is shown comprised of a cable 30 and two serial connectors 32 at the two distal ends of the cable 30. The cable 30 is comprised of four twisted pairs respectively formed of a signal wire 34 and a grounding wire 36.

Because each signal wire 34 is twisted with a respective grounding wire 36, the invention eliminates interference between signal wires 34. Because the signal wires 34 are respectively grounded, the length of the signal wires 34 does not affect the stability of the transmission of data of the serial ATA cable. Furthermore, because the invention eliminates the use of a hard plastic shell to wrap the wires, the serial ATA cable can easily be positioned in the host computer.

A prototype of serial ATA cable has been constructed with the features of FIGS. 3 and 4. The serial ATA cable functions smoothly to provide all of the features discussed earlier.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A serial ATA cable comprising a cable and two serial connectors at two distal ends of said cable, wherein said cable is comprised of four twisted pairs arranged in parallel, said twisted pairs each comprising a signal wire and a grounding wire twisted with said signal wire.
